(19) United States
(12) Patent Application Publication
(10) Pub. No.: US 2026/0186946 A1
(43) Pub. Date: Jul. 2, 2026

(54) FIRMWARE VERIFICATION SYSTEM AND FIRMWARE VERIFICATION METHOD

(71) Applicant: Moxa Inc., New Taipei City (TW)

(72) Inventors: Chao-Yeh Lai, New Taipei City (TW); Yi Chang, New Taipei City (TW)

(73) Assignee: Moxa Inc., New Taipei City (TW)

(21) Appl. No.: 19/002,776

(22) Filed: Dec. 27, 2024

(51) Int. Cl. G06F 11/3604

(52) U.S. Cl. CPC G06F 11/3608

(57) ABSTRACT

The embodiments of the disclosure provide a firmware verification method and a firmware verification system. The method includes: obtaining a firmware appended with padding data and a first hash value; generating a first on demand hash value according to the firmware appended with the padding data by using a first hash function; reading root of trust data from a one-time programmable memory; and verifying the firmware by comparing the first on demand hash value with the root of trust data.

### BACKGROUND

### 1. Field of the Invention

The present disclosure generally relates to a mechanism for ensuring firmware security, in particular, to a firmware verification system and a firmware verification method.

### 2. Description of Related Art

Firmware security is critical in various domains due to its role in ensuring the reliable operation of hardware devices. Unlike regular software, firmware is deeply embedded within the device's hardware and controls essential functions. Securing firmware is essential because any compromise can lead to significant vulnerabilities, potentially allowing attackers to manipulate device behaviour, steal sensitive information, or disable critical functions. Therefore, firmware verification is essential to protect firmware from unauthorized access and malicious manipulation.

The verification process typically involves cryptographic techniques such as hash functions. Specifically, a secure hash algorithm may be performed to a firmware when verifying the firmware, and the resulting hash value is compared against a hash value appended with the firmware. If the comparison result is different, the firmware may have been tampered with and should not be trusted. Therefore, hash verification ensures that firmware remains unchanged and secure throughout its transmission and deployment process, protecting against unauthorized modifications and ensuring system integrity. However, when both the firmware and its appended hash value are tampered with simultaneously, it indeed leads to a situation where the tampering of the firmware goes undetected. This occurs because the appended hash value is computed based on the invalid firmware itself. If an attacker can modify both the firmware and its appended hash value at the same time, the conventional verification process fails to detect such alterations.

### SUMMARY

Accordingly, the disclosure is directed to a firmware verification system and a firmware verification method, which may be used to solve the above technical problems.

The embodiments of the disclosure provide a firmware verification method. The method includes: obtaining a firmware appended with padding data and a first hash value; generating a first on demand hash value according to the firmware appended with the padding data by using a first hash function; reading root of trust data from a one-time programmable memory; and verifying the firmware by comparing the first on demand hash value with the root of trust data.

The embodiments of the disclosure provide a firmware verification system including a one-time programmable memory and a processor. The processor is coupled to the one-time programmable memory and is configured to: obtain a firmware appended with padding data and a first hash value; generate a first on demand hash value according to the firmware appended with the padding data by using a first hash function; read the root of trust data from the one-time programmable memory; and verify the firmware by comparing the first on demand hash value with the root of trust data.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 shows a schematic diagram of a firmware verification system according to an embodiment of the disclosure.

FIG. 2 shows a flow chart of firmware verification method according to an embodiment of the disclosure.

FIG. 3 shows a flow chart of verifying the firmware according to an embodiment of the disclosure.

FIG. 4 shows a schematic diagram of a firmware verification system according to an embodiment of the disclosure.

FIG. 5 shows a schematic diagram of a firmware verification system according to an embodiment of the disclosure.

FIG. 6 shows a flow chart of firmware verification method according to an embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

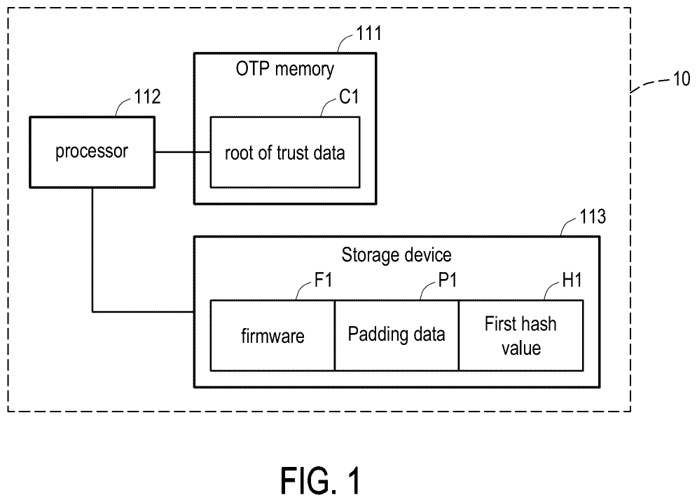

Referring to FIG. 1, which shows a schematic diagram of a firmware verification system according to an embodiment of the disclosure.

In FIG. 1, a firmware verification system 10 includes a one-time programmable (OTP) memory 111, a processor 112, and a storage device 113. The processor 112 may be coupled to the OTP memory 111 and the storage device 113. In various embodiments, the processor 112 may be connected to the OTP memory 111 and the storage device 113 through a serial interface, such as a serial peripheral Interface (SPI) or a I2C Interface. In various embodiments, the firmware verification system 10 may be implemented as an IoT device or any electronic device using embedded systems or microcontroller-based systems.

In some embodiments, the storage device 113 is one or a combination of a stationary or mobile random-access memory (RAM), read-only memory (ROM), flash memory, hard disk, or/and any other similar device, and which records a plurality of modules and/or a program code that can be executed by the processor 112.

Further, in some embodiments, the storage device 113 may record a firmware F1, padding data P1 appended with the firmware F1, and a first hash value H1. In some embodiments, the firmware F1 may be an executable image, also referred to as a firmware image. The executable image is stored, for example, as a binary image in the storage device 113. The first hash value H1 is configured for verifying integrity and validity of the firmware F1. The firmware F1, the padding data P1 appended with the firmware F1, and the first hash value H1 are provided to the firmware verification system 10 together during firmware burning or firmware updating.

In one embodiment, the storage device 113 recording the firmware F1 may be a non-volatile memory (NV memory), such as a ROM or a flash memory. The firmware F1, the padding data P1 appended with the firmware F1, and the first hash value H1 are burned onto the storage device 113. The processor 112 may be configured to execute the firmware F1 recorded in the storage device 113.

In one embodiment, the storage device 113 recording the firmware F1 may be a volatile memory, such as a random access memory (RAM). When preforming a firmware updating procedure, the processor 112 may receive the firmware F1, the padding data P1 appended with the firmware F1, and the first hash value H1 from a remote device, and the firmware F1, the padding data P1 appended with the firmware F1, and the first hash value H1 may be temporarily stored in the volatile memory. The processor 112 may be configured to use the firmware F1, the padding data P1 appended with the firmware F1, and the first hash value H1 recorded in the volatile memory to update the existing data in a NV memory.

The OTP memory 111, also known as a one-time programmable memory, is a static register that can only be written once, with its hardware circuitry guaranteeing that data written in the OTP memory 111 cannot be modified or lost. In some embodiments, the root of trust data C1 for verifying the firmware F1 is recorded in the OTP memory 111.

The processor 112 may be, for example, a general purpose processor, a special purpose processor, a conventional processor, a plurality of microprocessors, a controller, a microcontroller, Application Specific Integrated Circuits (ASICs), Field Programmable Gate Array (FPGAs) circuits, any other type of integrated circuit (IC), a state machine, and the like.

In some embodiments, the processor 112 may access the modules and/or the program code stored in the storage device 113 to implement the firmware verification method provided in the disclosure, which would be further discussed in the following.

In some embodiments, the processor 112 may verify the firmware F1 with the padding data P1 when performing a boot procedure, a firmware updating procedure or a firmware uploading procedure. In some embodiments, the processor 112 may verify the firmware F1 with the padding data P1 periodically or aperiodically. It should be noted that, the processor 112 may verify the firmware F1 with the padding data P1 by using the root of trust data C1 in the OTP memory 111. The root of trust data C1 in the OTP memory 111 cannot be modified after the OTP memory 111 leaves the factory. The processor 112 may generate a specific hash value by inputting the firmware F1 with the padding data P1 into a specific hash function. In some embodiments, if the specific hash value of the firmware F1 with the padding data P1 matches the root of trust data C1 in the OTP memory 111, the processor 112 may determine the firmware F1 is verified. If the specific hash value of the firmware F1 with the padding data P1 does not match the root of trust data C1 in the OTP memory 111, the processor 112 may determine the firmware F1 is not verified.

That is, a valid padding data appended to a valid firmware may be determined based on the root of trust data, such that the resulting hash value of the valid firmware with the valid padding data may be the same as the root of trust data. Namely, if the resulting hash value of a firmware with padding data is different from the root of trust data, the firmware and/or the padding data may be tampered with, and the invalid firmware can be prohibited from being loaded into RAM or executed.

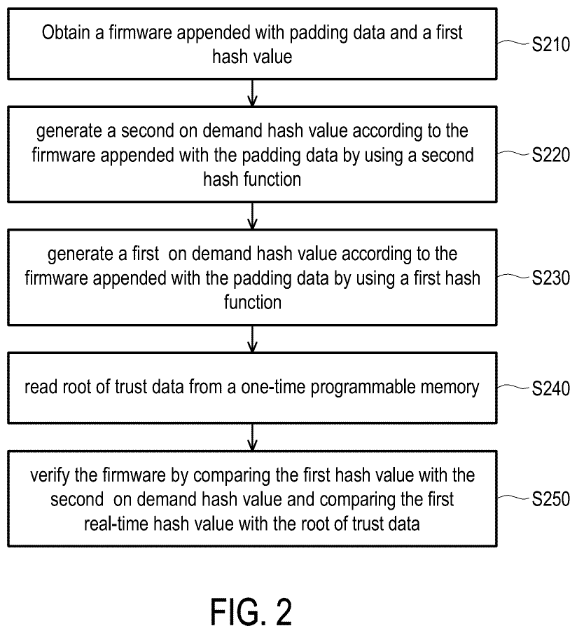

Referring to FIG. 2, which shows a flow chart of the firmware verification method according to an embodiment of the disclosure. The method of this embodiment may be executed by the firmware verification system 10 in FIG. 1, and the details of each step in FIG. 2 will be described below with the components shown in FIG. 1.

In step S210, the processor 112 may obtain a firmware F1 appended with padding data P1 and a first hash value H1. In some embodiments, the padding data P1 is appended after the firmware F1, and the first hash value H1 is appended after the padding data P1.

In some embodiments, the processor 112 may read the firmware F1 appended with the padding data P1 and the first hash value H1 from a non-volatile memory. When receiving a booting signal, the processor 112 may be configured to verify the firmware F1 in the non-volatile memory before loading the firmware F1. The processor 112 may obtain the firmware F1 appended with the padding data P1 and the first hash value H1 from the storage device 113 in response to receiving a booting signal.

In some embodiments, during a firmware updating procedure, the processor 112 may receive the firmware F1 appended with the padding data P1 and the first hash value H1 from a remote device through a network. In some embodiments, the firmware updating procedure may be an Over-the-Air (OTA) update procedure. When performing a firmware updating procedure, the processor 112 may be configured to verify the firmware F1 in the volatile memory before overwriting the non-volatile memory using the firmware F1. The processor 112 may obtain the firmware F1 appended with the padding data P1 and the first hash value H1 from the storage device 113 in response to receiving a firmware updating signal from a remote device.

In step S220, the processor 112 may generate a second on demand hash value according to the firmware F1 appended with the padding data P1 by using a second hash function. In detail, the processor 112 may input the firmware F1 appended with the padding data P1 into a second hash function to generate the second on demand hash value. The second hash function is a mathematical function that takes an input and produces a string, which typically represents the original input data in a condensed and unique form. The second hash function may be a secure hash algorithm, such as SHA-256, SHA-224, SHA-384 or the other secure hash algorithm.

In step S230, the processor 112 may generate a first on demand hash value according to the firmware F1 appended with the padding data P1 by using a first hash function. In detail, the processor 112 may input the firmware F1 appended with the padding data P1 into a first hash function to generate the first on demand hash value. The first hash function is a mathematical function that takes an input and produces a string, which typically represents the original input data in a condensed and unique form. The first hash function may be a secure hash algorithm, such as SHA-256, SHA-224, SHA-384 or the other secure hash algorithm.

In some embodiments, the first hash function may be different from the second hash function. For example, the first hash function may be a SHA-256 function, and the second hash function may be a SHA-512 function, but the disclosure is not limited thereto.

In some embodiments, the first hash function may be identical with the second hash function. For example, the first hash function and the second hash function may both be a SHA-256 function, but the disclosure is not limited thereto.

In step S240, the processor 112 may read root of trust (ROT) data C1 from a one-time programmable memory 111. In some embodiments, the ROT data C1 may be a predetermined constant value. In some embodiments, the RoT data C1 may be a product serial number or a hardware number. The RoT data C1 recorded in the OTP memory 111 is read-only data and can not be modified. The OTP memory 111 may be an electronic fuse (eFuse).

In step S250, the processor 112 may verify the firmware F1 by comparing the first hash value H1 with the second on demand hash value and comparing the first on demand hash value with the root of trust data C1. That is, the second on demand hash value generated by the second hash function may be compared with the first hash value H1 provided with the firmware F1. The first on demand hash value generated by the first hash function may be compared with the root of trust data C1 in OTP memory 111.

In some embodiments, the processor 112 may determine the firmware F1 is verified in response to that the first hash value H1 matches the second on demand hash value and the first on demand hash value matches the root of trust data C1. That is, the firmware F1 is validated if the first hash value H1 is identical with the second on demand hash value and the root of trust data C1 is identical with the first on demand hash value.

In some embodiments, the processor 112 may determine the firmware F1 is not verified in response to that the first hash value H1 does not match the second on demand hash value or the first on demand hash value does not match the root of trust data C1. That is, the firmware F1 is not validated if the first hash value H1 is different from the second on demand hash value or the root of trust data C1 is different from the first on demand hash value.

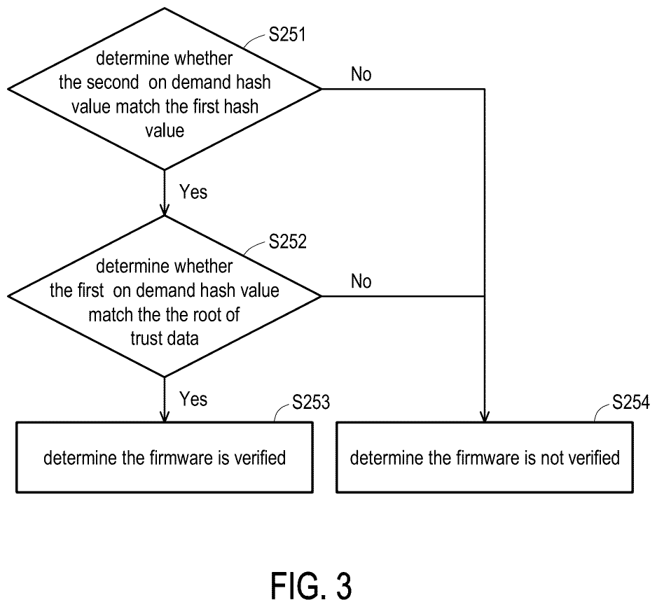

Referring to FIG. 3, which shows a flow chart of verifying the firmware according to an embodiment of the disclosure. In some embodiments, the step S250 may be implemented as the step S251 to the step S254 in FIG. 3.

In step S251, the processor 112 may determine whether the second on demand hash value matches the first hash value H1. If the second on demand hash value doe not match the first hash value H1 (the determining result of step S251 is no), in step S254, the processor 112 may determine the firmware F1 is not verified. If the second on demand hash value matches the first hash value H1, in step S252, the processor 112 may determine whether the first on demand hash value matches the root of trust data C1. If the first on demand hash value doe not match the root of trust data C1 (the determining result of step S252 is no), in step S254, the processor 112 may determine the firmware F1 is not verified. If the first on demand hash value matches the root of trust data C1 (the determining result of step S252 is yes), in step S253, the processor 112 may determine the firmware F1 is verified.

Based on the above, because the processor 112 verifies firmware F1 using the root of trust data C1 and the root of trust data C1 stored in OTP memory 111 cannot be modified, tampering with firmware F1 and the first hash value H1 can be detected. If the first on demand hash value doe not match the root of trust data C1, the firmware F1 and/or the first hash value H1 may be tampered with. Further, the use of different hash functions by the processor 112 to verify firmware can significantly enhance firmware security.

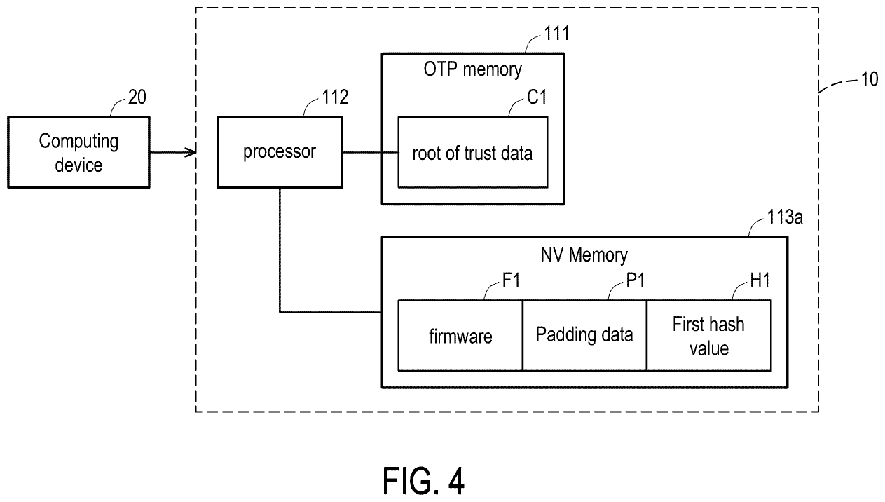

FIG. 4 shows a schematic diagram of a firmware verification system according to an embodiment of the disclosure. Referring to FIG. 4, a computing device 20 including a processor and the storage circuit may be a computer, a server or other firmware programming device, which is not limited in the disclosure. A computing device 20 may burn the firmware F1, the padding data P1 and the first hash value H1 onto the NV memory 113a. The computing device 20 may generate the padding data P1 based on the firmware F1, the root of trust data C1 and the first hash function. Further, the computing device 20 may generate the first hash value H1 by inputting the firmware F1 into the second hash function.

In FIG. 4, the processor 112 may verify the firmware F1 recorded in the NV memory 113a according to the operations described in the above embodiments. If the firmware F1 recorded in the NV memory 113a is verified, the firmware F1 may be loaded into a RAM and be executed by the processor 112.

In some embodiments, the processor 112 may verify the firmware F1 in the NV memory 113a before executing a Bootloader in ROM or flash memory. In some embodiments, the processor 112 may verify the firmware F1 in the NV memory 113a after executing a Bootloader in ROM or flash memory. In some embodiments, the processor 112 may verify the firmware F1 during a firmware updating procedure or a firmware uploading procedure. The processor 112 may verify the firmware F1 in response to receiving the firmware F1 from a cloud server or a local device.

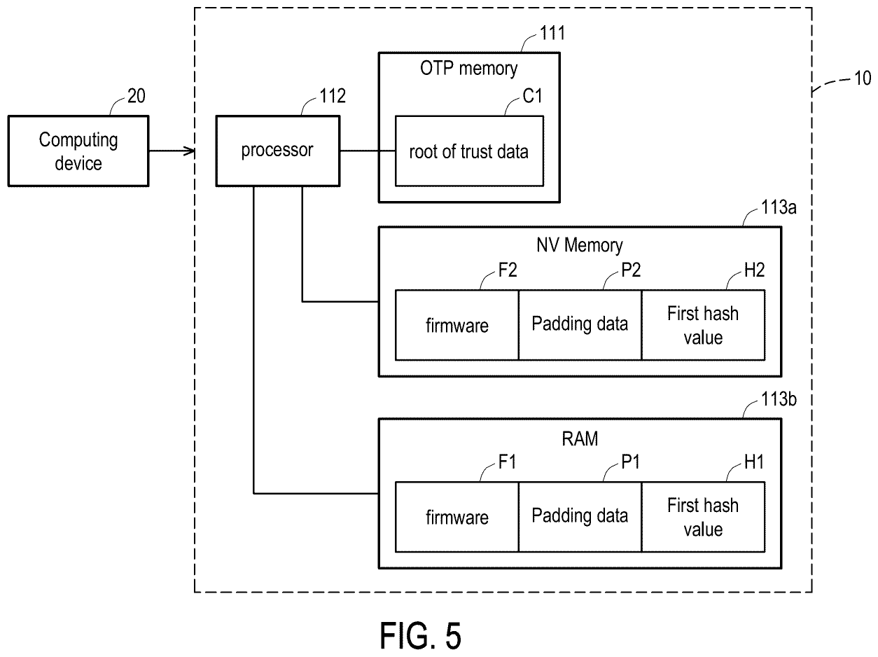

FIG. 5 shows a schematic diagram of a firmware verification system according to an embodiment of the disclosure. Referring to FIG. 5, a computing device 20 including a processor and the storage circuit may be a computer or a server, which is not limited in the disclosure. A computing device 20 (i.e. a remote device) may transmit the firmware F1, the padding data P1 and the first hash value H1 to the firmware verification system 10 through network. For example, in on the air (OTA) update, the computing device 20 may control the firmware verification system 10 to perform the firmware updating via the network. The padding data P1 may be determined by the computing device 20 based on the firmware F1, the root of trust data C1 and the first hash function. Further, the computing device 20 may generate the first hash value H1 by inputting the firmware F1 into the second hash function.

In FIG. 5, the processor 112 may temporally store the firmware F1 the padding data P1 and the first hash value H1 in the RAM 113b in response to receiving the firmware F1 the padding data P1 and the first hash value H1, and then the processor 112 may verify the firmware F1 recorded in the RAM 113b according to the operations described in the above embodiments. During the firmware updating procedure, if the firmware F1 recorded in the RAM 113b is verified, the processor 112 may replace the firmware F2, the padding data P2 and the first hash value H2 with the firmware F1, the padding data P1 and the first hash value H1 to refresh the NV memory 113a.

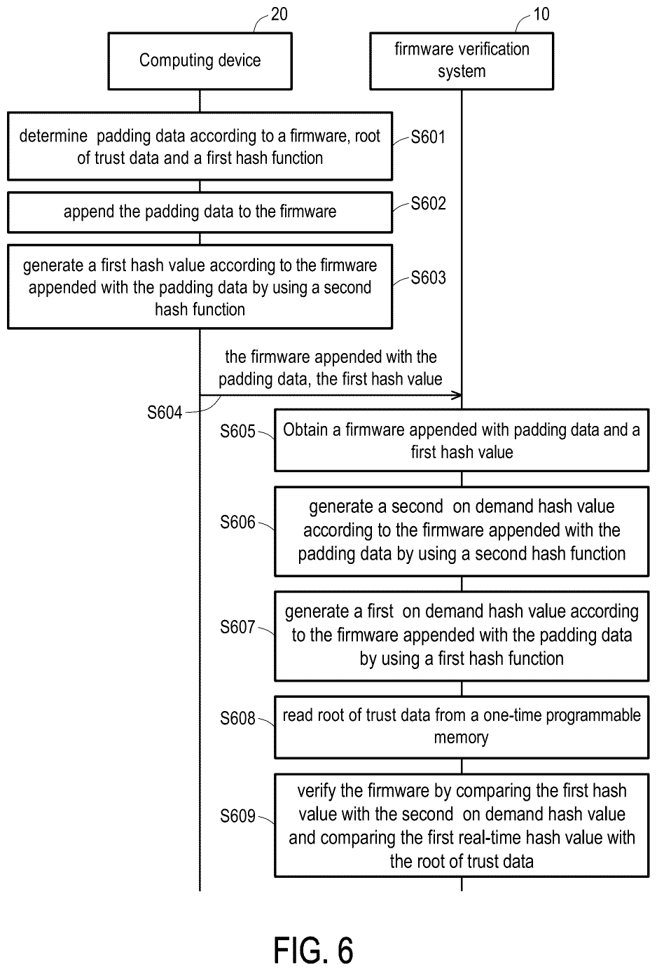

FIG. 6 shows a flow chart of firmware verification method according to an embodiment of the disclosure. Referring to FIG. 6, in step S601, the computing device 20 may determine padding data according to a firmware, a root of trust data and a first hash function.

In some embodiments, the relationship between the padding data, the firmware and the root of trust data may be represented as:

$$c = {h}^{′} ( fw + p )$$

wherein the fw is the firmware, p is the padding data, h′(·) is the first hash function, and c is the root of trust data.

In some embodiments, the padding data is determined by setting the root of trust data as an output hash value of the first hash function. The padding data may be derived based on the firmware and the root of trust data are known. For example, after obtaining the firmware and the root of trust data, the computing device 20 may determine the padding data by using brute force attack.

In step S602, the computing device 20 may append the padding data to the firmware. In some embodiments, the padding data may be appended to the end of the firmware. In some embodiments, the padding data may be appended to the beginning of the firmware. The string length of the padding data is determined based on the first hash function.

In step S603, the computing device 20 may generate the first hash value according to the firmware appended with the padding data by using the second hash function. In some embodiments, the relationship between the firmware with the padding data and the first hash value may be represented as:

$${hv}_{p} = h ( {fw}_{p} )$$

wherein the f^{w}ₚ is the firmware appended with the padding data, h(·) is the second hash function, and the hvₚ is the first hash value.

In step S604, the computing device 20 may provided the firmware appended with padding data and the first hash value to the firmware verification system 10. In step S605, the firmware verification system 10 may obtain a firmware appended with padding data and a first hash value. In step S606, the firmware verification system 10 may generate a second on demand hash value according to the firmware appended with the padding data by using a second hash function. In step S607, the firmware verification system 10 may generate a first on demand hash value according to the firmware appended with the padding data by using a first hash function. In step S608, the firmware verification system 10 may read root of trust data from a one-time programmable memory. In step S609, the firmware verification system 10 may verify the firmware by comparing the first hash value with the second on demand hash value and comparing the first on demand hash value with the root of trust data. The detail of the step S604 to step s609 may be referred to the embodiments described above.

In summary, the embodiments of the disclosure provide solutions for improving firmware security. By appending the padding data and using the root of trust data recorded in the OTP memory to verify the firmware, tampering with the firmware, padding data, and hash value can all be detected. Further, based on the two-stage hash verification using different hash functions, the probability of a successful attack on the firmware is greatly reduced, causing the legality and integrity of the firmware to be ensured.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A firmware verification method, comprising:
obtaining a firmware appended with padding data and a first hash value;
generating a first on demand hash value according to the firmware appended with the padding data by using a first hash function;
reading root of trust data from a one-time programmable memory; and
verifying the firmware by comparing the first on demand hash value with the root of trust data.

2. The method according to claim 1, further comprising:
generating a second on demand hash value according to the firmware appended with the padding data by using a second hash function,
wherein the step of verifying the firmware by comparing the first on demand hash value with the root of trust data comprises:
verifying the firmware by comparing the first on demand hash value with the root of trust data and comparing the second on demand hash value with the first hash value.

3. The method according to claim 2, further comprising:
determining the firmware is verified in response to that the first hash value matches the second on demand hash value and the first on demand hash value matches the root of trust data.

4. The method according to claim 2, further comprising:
determining the firmware is not verified in response to that the first hash value does not match the second on demand hash value or the first on demand hash value does not match the root of trust data.

5. The method according to claim 2, wherein the first hash function is different from the second hash function.

6. The method according to claim 1, wherein the step of obtaining the firmware appended with the padding data and the first hash value comprises:
reading the firmware appended with the padding data and the first hash value from a non-volatile memory.

7. The method according to claim 1, wherein the step of obtaining the firmware appended with the padding data and the first hash value comprises:
during a firmware updating procedure, receiving the firmware appended with the padding data and the first hash value from a remote device through a network.

8. The method according to claim 1, further comprising:
determining the padding data according to the firmware, the root of trust data and the first hash function; and
appending the padding data to the firmware.

9. The method according to claim 8, further comprising:
generating the first hash value according to the firmware appended with the padding data by using the second hash function.

10. The method according to claim 5, wherein the padding data is determined by setting the root of trust data as an output hash value of the first hash function.

11. A firmware verification system, comprising:
a one-time programmable memory, recording root of trust data; and
a processor, configured to:
obtain a firmware appended with padding data and a first hash value;
generate a first on demand hash value according to the firmware appended with the padding data by using a first hash function;
read the root of trust data from the one-time programmable memory; and
verify the firmware by comparing the first on demand hash value with the root of trust data.

12. The firmware verification system according to claim 10, wherein the processor is further configured to:
generate a second on demand hash value according to the firmware appended with the padding data by using a second hash function; and
verify the firmware by comparing the first on demand hash value with the root of trust data and comparing the second on demand hash value with the first hash value.

13. The firmware verification system according to claim 12, wherein the processor is further configured to:
determine the firmware is verified in response to that the first hash value matches the second on demand hash value and the first on demand hash value matches the root of trust data.

14. The firmware verification system according to claim 12, wherein the processor is further configured to:
determine the firmware is not verified in response to that the first hash value does not match the second on demand hash value or the first on demand hash value does not match the root of trust data.

15. The firmware verification system according to claim 12, wherein the first hash function is different from the second hash function.

16. The firmware verification system according to claim 11, further comprising a non-volatile memory, wherein the processor is further configured to:
read the firmware appended with the padding data and the first hash value from the non-volatile memory.

17. The firmware verification system according to claim 11, wherein the processor is further configured to:
during a firmware updating procedure, receive the firmware appended with the padding data and the first hash value from a remote device through a network.

18. The firmware verification system according to claim 11, wherein the padding data is determined by setting the root of trust data as an output hash value of the first hash function.
